(19) United States
(12) Patent Application Publication
(10) Pub. No.: US 2016/0141896 A1
(43) Pub. Date: May 19, 2016

(54) A SEGMENTED FUEL CELL-BATTERY PASSIVE HYBRID SYSTEM

(71) Applicant: IMPERIAL INNOVATIONS LIMITED, London (GB)

(72) Inventors: Nigel P. Brandon, Surrey (GB); Gregory Offer, Guildford (GB); Billy Wu, London (GB); Vladimir Yufit, London (GB)

(21) Appl. No.: 14/896,484

(22) PCT Filed: Jan. 9, 2014
(86) PCT No.: PCT/GB2014/051769

§ 371 Date: Dec. 7, 2015

(30) Foreign Application Priority Data
Jun. 7, 2013 (GB) 1310213.2

(51) Int. Cl. H02J 7/00; H01M 10/42; H01M 16/00

(52) U.S. Cl. CPC H02J 7/0021; H01M 16/003; H01M 16/006; H01M 10/425; H01M 2010/4271; H01M 2220/20; H01M 2250/20; H02J 7/345

(57) ABSTRACT

An apparatus for supplying electrical energy to a varying load is disclosed. The apparatus comprises fuel cells and energy storage devices. A fuel cell subset comprises one or a plurality of series-connected ones of the fuel cells, having a first no-load open-circuit potential thereacross and is connected in parallel with an energy storage device subset comprising one or a plurality of series-connected ones of the energy storage devices, having a second no-load open-circuit potential thereacross, to form a unit. The unit cell is connected in series or parallel with at least one other unit cell. The fuel cells in the unit cell and the at least one other unit cell are fuel cells of the same fuel cell stack. The arrangement is such that first no-load open-circuit potential and the second no-load open circuit potential are substantially balanced.

### FIELD

This invention relates to an apparatus for supplying electrical energy to a varying load. In particular, embodiments relate to a segmented fuel cell-battery arrangement forming part of a hybrid electric vehicle drivetrain. The invention also relates to an apparatus for receiving electrical energy from a varying source.

### BACKGROUND

[Pure Battery Systems]

In recent years, against a background of increasing oil prices and concerns relating to CO₂ emissions causing climate change, there has been a drive to develop zero-emission technologies for automotive applications. Many automotive manufacturers are in the process of releasing battery-powered electric vehicles, where a preferred technology is the lithium-ion battery. Battery-powered electric vehicles have the advantage of being zero-emission but the technology is limited by the gravimetric energy density of batteries which limits the effective range of the vehicle. Recharging times of up to 8 hours are also an impediment to getting consumers to move to battery-powered vehicles.

Lithium-ion batteries also suffer from the drawback of having a finite safe-operating region, outside of which operation is unsafe. At cell voltages below this region, the copper anode current collector dissolves and redeposits on the cathode leading to short circuits. Above the safe operating voltage region, there may be lithium plating or cathode breakdown during charging, leading to capacity loss. It is therefore important to keep cell voltages within the safe operating voltage range for the cell.

In use, lithium-ion cells are connected to form battery packs. Current battery pack designs contain many cells connected in series to increase pack voltage and in parallel to increase current and capacity. Due to manufacturing and operating condition variations, the voltages of each cell will invariably differ slightly from the others. Over the lifetime of a battery pack, depending on the operating conditions and the pack architecture, different cells may degrade at different rates. As a result, over time, the difference in cell voltages becomes apparent, with cells with reduced capacity reaching the safe voltage cut-off earlier than the other cells. In order to keep the cell voltages balanced and therefore keep the pack within safe operating limits, battery packs in battery-powered vehicles require a Battery Management System (BMS) which actively balances the cell voltages either by shuffling charge between cells or shunting current from charged cells to prevent an overcharge. If not rebalanced, the cell voltages can lead to reduced performance of the system, accelerated degradation or even a catastrophic failure. The BMS adds an extra cost to the system.

[Pure Fuel Cell Systems]

An alternative technology being developed by automotive manufacturers is the low-temperature Proton Exchange Membrane Fuel Cell (PEMFC). PEMFCs use hydrogen as a chemical fuel stock, and convert this into electricity with the only by-products being water and heat, allowing for local zero-emission power generation. In contrast to batteries, PEMFCs have a very high energy density, limited only by the amount of hydrogen that can be stored. Since PEMFCs run on a chemical fuel, a vehicle powered by a PEMFC stack can be refuelled in the same length of time as a conventional internal combustion vehicle, giving all the zero-emission benefits of battery electric vehicles without the disadvantages of low range and long refuelling time.

In a pure fuel cell vehicle, the fuel cell arrangement has to be sized to the peak power requirement of the vehicle in order to achieve the performance requirements expected by the user. This peak power requirement can be in the region of 120 kWe. The average power requirement of an automotive drive cycle is typically around 10-30 kWe. However, most of the time, the fuel cell does not operate at its full power. This is inefficient. Pure fuel cell vehicles require a large number of fuel cells and are therefore expensive. A further drawback is that no regenerative braking is possible since fuel cells cannot be recharged.

[Hybrid Systems with DC-to-DC Converter]

A hybrid system uses both energy storage devices and a fuel cell stack, allowing for potential down-sizing of components and cost savings. In a hybrid vehicle, the fuel cell stack is sized to the average power requirement of the drive cycle, rather than the peak requirements as in a pure fuel cell vehicle, and energy storage devices provides the peak power requirements. These vehicles therefore require a smaller fuel cell than is needed in pure fuel cell vehicles, and use the energy storage device, such as a battery pack or supercapacitor bank, to meet peak power requirements. Hybrid vehicles can recover regenerative braking energy through re-charging of the energy storage device.

In order to manage power flows in this configuration, DC-to-DC converters are connected between the energy storage device and the motor controller and between the fuel cell stack and the motor controller to distribute power taken from the energy storage device and fuel cell stack while the vehicle is being run. The DC-to-DC converters add significant extra cost to the system and additional losses due to the inherent resistances of the components.

As with purely battery-powered vehicles, a BMS must be used to rebalance the cells in series with one another. Again, this adds significantly to the cost of the system and results in additional losses.

[Passive Hybrid Systems]

In a passive hybrid system, there is direct coupling of the fuel cell stack to the battery pack or supercapacitor bank. The system has the same operating voltage as the fuel cell hybrid discussed above, but there is no active control of power flows. This removes the need for a DC-to-DC converter and therefore lowers the cost of the system, when compared to the fuel cell hybrid just discussed. Ripple currents from the power electronics are also decreased. In a passive hybrid system, there is a constant load on the fuel cell stack. This maximises the lifetime of the fuel cell stack, which is an expensive component of the powertrain.

Since, as with the pure battery system and the hybrid system with a DC-to-DC converter discussed above, the battery cells are likely to have different capacitances and since they are still connected in series, the cell voltages will deviate over time. A BMS must also, therefore, be used in a passive hybrid system to rebalance the cells in the same string, adding significantly to the cost of the system and resulting in additional losses.

Existing systems therefore require either a DC-to-DC converter in combination with a BMS, in the case of hybrid systems where the fuel cell stack is not coupled to the energy storage device, or, in passive hybrid systems or pure battery systems, a BMS alone. These electric components add to the cost, complexity and weight of the system. It is therefore desirable to address these disadvantages.

### SUMMARY

According to a first aspect of this invention, there is provided an apparatus for supplying electrical energy to a varying load, the apparatus comprising fuel cells and energy storage devices, wherein a fuel cell subset comprising one or a plurality of series-connected ones of the fuel cells, having a first no-load open-circuit potential thereacross, is connected in parallel with an energy storage device subset comprising one or a plurality of series-connected ones of the energy storage devices, having a second no-load open-circuit potential thereacross, to form a unit cell and the unit cell is connected in series or parallel with at least one other unit cell, and the fuel cells in the unit cell and the at least one other unit cell are fuel cells of the same fuel cell stack, wherein the first no-load open-circuit potential and the second no-load open circuit potential are substantially balanced.

As a result, in a preferred embodiment, the no-load open circuit potential across the fuel cell subset is substantially the same as the no-load open circuit potential across the charged energy storage device subset. This means that when the fuel cell subset and the energy storage device subset, when substantially fully charged, are connected in parallel, substantially no current flows, so that the or each energy storage device is not over-charged. When the state of charge of the or each energy storage device is less than fully charged, the no-load open circuit potential across the energy storage device subset is slightly less than that across the fuel cell subset, such that current flows and the or each energy storage device is charged. In other words, the system displays both static and dynamic equilibrium.

In at least certain embodiments, by connecting a subset of the plurality of fuel cells in parallel with a subset of the plurality of energy storage devices such that the voltages thereacross are substantially balanced, the need for a DC-to-DC converter to distribute power taken from the energy storage devices and fuel cells is removed. This lowers significantly the cost of the system. It also eliminates efficiency losses from voltage conversion by the DC-to-DC converter. Furthermore, the absence of a DC-to-DC converter reduces ripple currents from power electronics, slowing down the degradation of electrochemical components in the system.

In at least certain embodiments, by connecting a subset of the plurality of fuel cells in parallel with a subset of the plurality of energy storage devices, the size of fuel cell stack required to give a particular power rating can be reduced, since the energy storage devices contribute towards the total power produced. Reducing the size of the fuel cell stack reduces cost.

In at least certain embodiments, by connecting a subset of the plurality of fuel cells in parallel with a subset of the plurality of energy storage devices, the risk of failure of an individual fuel cell due to transient conditions such as fuel starvation or flooding can be reduced. This is because if one fuel cell experiences sub-optimal operating conditions, the energy storage devices take more of the load, thereby reducing the risk of failure. Furthermore, in at least certain embodiments, connecting a subset of the plurality of fuel cells in parallel with a subset of the plurality of energy storage devices allows the apparatus to continue to function even if a fuel cell fails. This is because current may flow through the or each energy storage device of the unit cell in which the failed fuel cell is located, providing an alternative current route. Alternatively, if an energy storage device fails, a fuel cell in the unit cell in which the failed energy storage device I located may continue to work. In both cases, catastrophic failure as result of one malfunctioning component can be prevented. This is not the case in existing systems when the failure of only one fuel cell or energy storage device can cause the failure of the whole hybrid system.

In at least certain embodiments, connecting a subset of the plurality of fuel cells in parallel with a subset of the plurality of energy storage devices allows energy storage devices with different capacities to be connected in series, allowing for the possibility of an integrated low-voltage circuit. This can eliminate the need for separate or additional low-voltage energy storage devices in applications where both high and low power is required, thereby potentially reducing the cost of the system.

The fuel cells may be hydrogen fuel cells. They may be proton exchange membrane fuel cells. The fuel cells may be solid oxide fuel cells, alkaline fuel cells, molten carbonate fuel cells, microbial fuel cells, direct alcohol fuel cells, direct borohydride fuel cells, regenerative fuel cells, or any other type of fuel cell.

In at least certain embodiments, by connecting a subset of the plurality of fuel cells in parallel with a subset of the plurality of energy storage devices, the fuel cells will almost always have a load on them. This prevents the fuel cells from being at an open circuit potential for extended periods. This in turn can allow longer fuel cell lifetimes, since high fuel cell potentials can lead to the corrosion of carbon based components within a fuel cell, and therefore performance degradation.

The energy storage devices may be batteries. They may be lithium-ion batteries. The energy storage devices may be nickel metal hydride batteries, lead acid batteries, Na/NiCl₂ batteries, Na/S batteries, Ni/Cd batteries or Li/S batteries. The energy storage devices may be metal-air batteries, including lithium-air batteries. The energy storage devices may be rechargeable batteries. The energy storage devices may conceivably be any other aqueous or non-aqueous batteries. The energy storage devices may be regenerative fuel cells. The energy storage devices may be redox-flow batteries. The energy storage devices may be all-vanadium batteries. They may be Zn/Br batteries or H/Br batteries. The energy storage devices may be supercapacitors.

In at least certain embodiments, connecting a subset of the plurality of fuel cells in parallel with a subset of the plurality of energy storage devices eliminates the need for a battery management system to keep the voltages of the energy storage devices balanced. This can reduce the cost of the system, while ensuring safe operation of the battery pack.

The unit cells may be arranged to prevent charging of the or each fuel cell in the unit cell by the or each energy storage device to which the or each fuel cell is connected in a unit cell. There may be a diode or a functionally equivalent device in each unit cell, connected to prevent charging of the or each fuel cell in the unit cell by the or each energy storage device to which the or each fuel cell is connected in a unit cell. A diode may be connected between each fuel cell subset and the respective energy storage device subset to which that fuel cell subset is connected. The diodes may be silicone diodes. They may be Schottky diodes. There may be a switching device connected in series with the energy storage device and in parallel with the or each fuel cell in the or each unit cell.

There may be a, or a respective, electrically insulating layer between the fuel cells of one unit cell and the adjacent fuel cell of the or each unit cell to which the one unit cell is physically adjacent. The material forming the electrically insulating layer may be selected to allow gas to pass between the fuel cells of different unit cells.

In a preferred embodiment, there is one energy storage device in a unit cell and four fuel cells. In other embodiments, there may be a plurality of energy storage devices and more or fewer fuel cells. A consideration here is the safe operating voltage range of the energy storage devices used. Since the or each fuel cell in a unit cell is connected in parallel with the or each energy storage device in the unit cell, the voltage across the fuel cell or the collective voltage across the fuel cells will be in balance with (or matched to) the voltage across the energy storage device or the collective voltage across the energy storage devices. The number of fuel cells in a unit cell is therefore selected such that the voltage across the or each fuel cell (collectively) is substantially in balance with the voltage at which the energy storage device or devices can operate safely. It will be understood by the skilled person that in order for current to flow from the fuel cell to the energy storage device, a potential difference must exist between them. The voltage across the fuel cell or the collective voltage across the fuel cells will not always, therefore, be the same as the voltage across the energy storage device or the collective voltage across the energy storage devices.

According to a second aspect of the invention, there is provided an apparatus for supplying electrical energy to a varying load, the apparatus comprising supercapacitors and energy storage devices, wherein a supercapacitor subset comprising one or a plurality of series-connected ones of the supercapacitors, having a first no-load open-circuit potential thereacross, is connected in parallel with an energy storage device subset comprising one or a plurality of series-connected ones of the energy storage devices, having a second no-load open-circuit potential thereacross, to form a unit cell and the unit cell is connected in series or parallel with at least one other unit cell, wherein the first no-load open-circuit potential and the second no-load open circuit potential are substantially balanced.

Optional features of the first aspect are optional features of the second aspect, substituting “supercapacitors” for “fuel cells”, as would be understood by the person skilled in the art.

According to a third aspect of this invention, there is provided a vehicle drivetrain comprising an apparatus as defined hereinabove.

According to a fourth aspect of this invention, there is provided a vehicle comprising an apparatus as defined hereinabove. The vehicle may be a fuel cell electric vehicle. It may be a hybrid electric vehicle, comprising an internal combustion engine. It may be a passenger vehicle.

In at least certain embodiments, connecting a subset of the plurality of fuel cells in parallel with a subset of the plurality of energy storage devices in a vehicle allows the apparatus to absorb regenerative braking energy through recharging of the energy storage devices. This is not possible with a pure fuel cell vehicle.

According to a fifth aspect of this invention, there is provided an uninterruptible power supply comprising an apparatus as defined hereinabove.

According to a sixth aspect of this invention, there is provided an apparatus for receiving electrical energy from a varying source, the apparatus comprising fuel cells and energy storage devices, wherein a fuel cell subset comprising one or a plurality of series-connected ones of the fuel cells, having a first no-load open-circuit potential thereacross, is connected in parallel with an energy storage device subset comprising one or a plurality of series-connected ones of the energy storage devices, having a second no-load open-circuit potential thereacross, to form a unit cell and the unit cell is connected in series or parallel with at least one other unit cell, and the fuel cells in the unit cell and the at least one other unit cell are fuel cells of the same fuel cell stack, wherein the first no-load open-circuit potential and the second no-load open circuit potential are substantially balanced.

Optional features of each aspect are also optional features of each other aspect.

### BRIEF DESCRIPTION OF THE DRAWINGS

Specific embodiments will be described below by way of example only and with reference to the accompanying drawings, in which:

FIG. 1 is a schematic diagram of a vehicle drivetrain including a segmented fuel cell-battery arrangement;

FIG. 2 shows a schematic circuit diagram of the segmented fuel cell-battery arrangement;

FIG. 3 shows a schematic diagram of the physical arrangement of one fuel cell sub-stack of the segmented fuel cell-battery arrangement;

FIG. 4 shows the polarisation curve of a fuel cell;

FIG. 5 shows the discharge curve of a lithium-ion battery;

FIG. 6 shows the initial current response of the segmented fuel cell-battery arrangement to a dynamic load;

FIG. 7 shows the currents in the segmented fuel cell-battery arrangement under the dynamic load over a longer period of time;

FIG. 8a shows the voltage response of the segmented fuel cell-battery arrangement to a dynamic load;

FIG. 8b again shows the current response of the segmented fuel cell-battery arrangement to the dynamic load;

FIG. 9 shows the variation of state-of-charge of different batteries in the segmented fuel cell-battery arrangement;

FIG. 10a shows the voltage response of the segmented fuel cell-battery arrangement to a constant load;

FIG. 10b shows the current response of the segmented fuel cell-battery arrangement to the constant load; and

FIG. 11 shows a schematic circuit diagram of an alternative embodiment of the segmented fuel cell-battery arrangement.

### SPECIFIC DESCRIPTION OF CERTAIN EXAMPLE EMBODIMENTS

[Components and Arrangement]

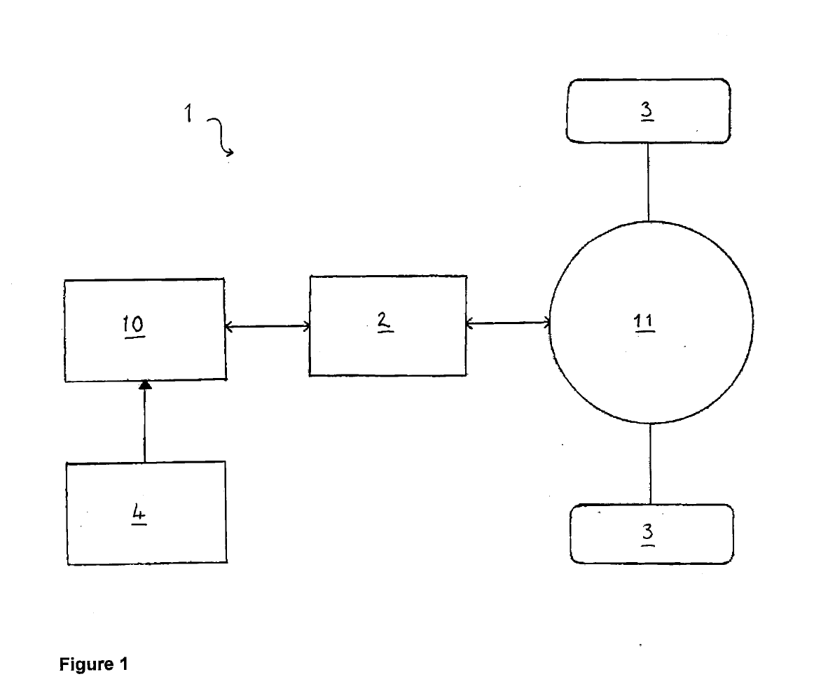

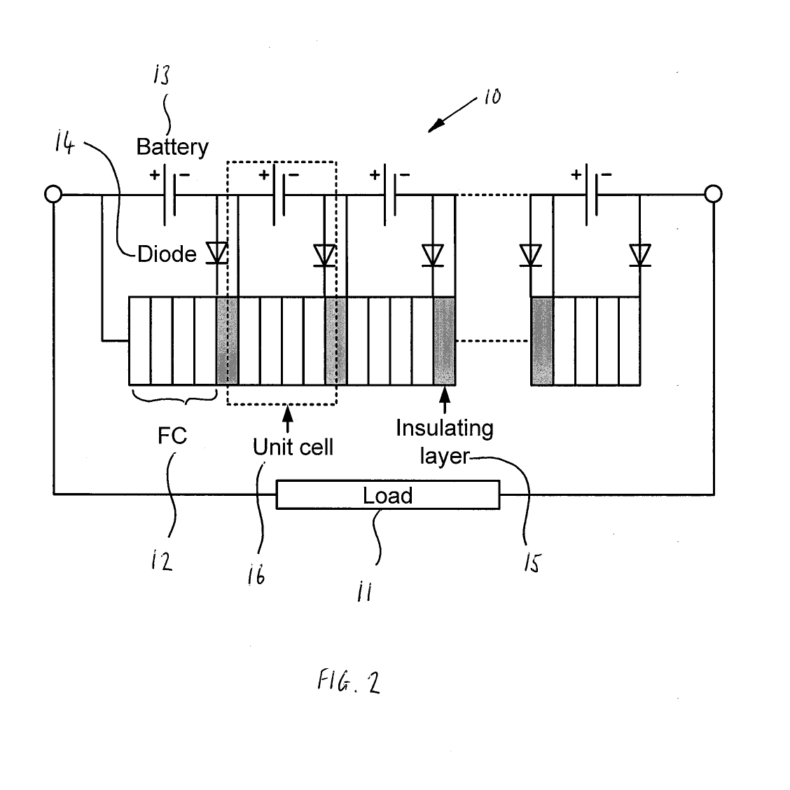

FIG. 1 shows a vehicle drivetrain 1 including an apparatus for supplying a varying load in the form of a segmented fuel cell-battery arrangement 10. The drivetrain 1 is for a hybrid electric vehicle (not shown). In this embodiment, the vehicle is a passenger car. In other embodiments, it could conceivably be any other form of automotive vehicle, for example a bus, tram or commercial vehicle. The segmented fuel cell-battery arrangement 10 (described in more detail below with reference to FIG. 2) is electrically connected to a motor controller 2 to which, in operation, it supplies electrical energy. The motor controller 2 is electrically connected to a motor 11 to controllably operate the motor. The motor is mechanically coupled to drive wheels 3 of the vehicle to move the vehicle. The segmented fuel cell-battery arrangement 10, hereinafter also referred to as “the arrangement” 10 is connected to a source 4 of gaseous hydrogen which supplies fuel cells 12 within the arrangement 10 with hydrogen. In this embodiment, the hydrogen is supplied from cylinders of compressed hydrogen. In other embodiments, the hydrogen may be stored in some other way.

FIG. 2 shows the segmented fuel cell-battery arrangement 10. The remainder of the drivetrain 1 to which it is connected is not shown. The motor 11 is represented in this schematic by a load 11. The arrangement 10 of this embodiment is made up of a fuel cell stack that has been modified and connected in a particular way to battery cells 13. This will all now be described in more detail.

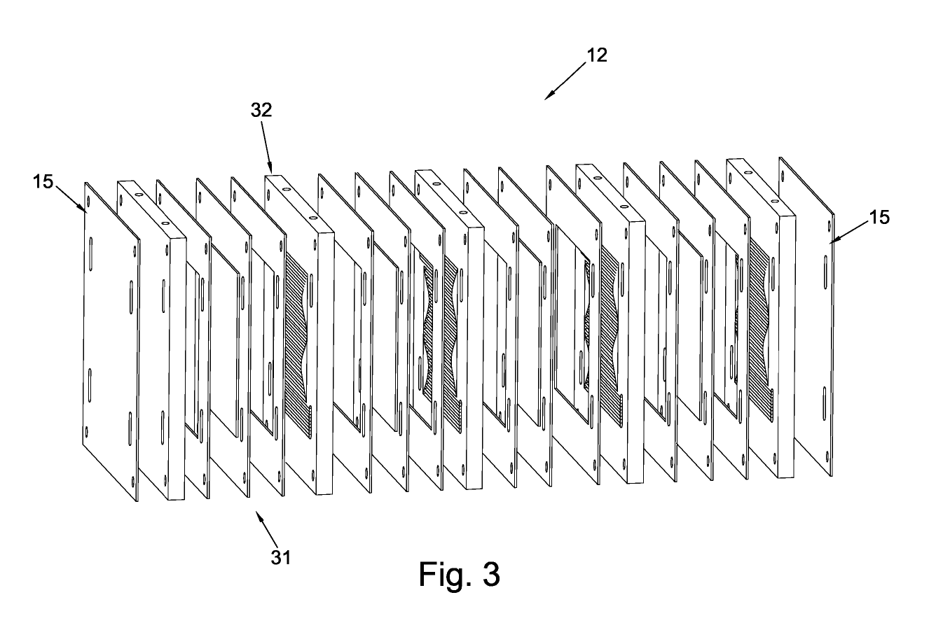

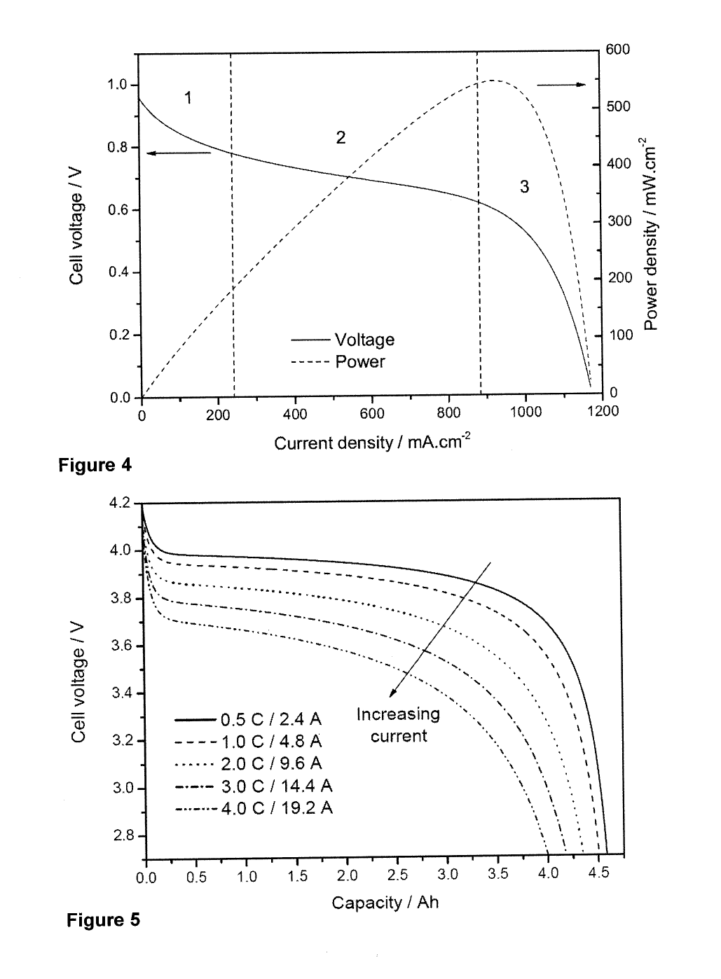

The fuel cell stack of this embodiment is composed of low-temperature Proton Exchange Membrane Fuel Cells (PEMFC). As mentioned, PEMFCs use hydrogen as a chemical fuel stock, and convert this into electricity with the only by-products being water and heat. They have a high energy density when compared to batteries. As in a conventional fuel cell stack, the fuel cell stack of this embodiment is supplied with hydrogen fuel from the hydrogen source 4 and with oxygen from the environment. These gases flow through the entire fuel cell stack. In contrast to a conventional fuel cell stack, however, the fuel cell stack of this embodiment has been modified by the insertion of an insulating layer 15 between each group of four fuel cells, forming fuel cell sub-stacks 12 electrically insulated from one another by the insulating layers 15. The insertion of these layers 15 between fuel cells of the fuel cell stack necessitates a re-design and change in the manufacturing process compared with conventional fuel cell stacks. The insulating layers 15 allow hydrogen and oxygen to pass through the length of the fuel cell stack. In this embodiment, the insulating layers 15 divide the fuel cell stack into sub-stacks 12 made up of four PEMFCs. The individual fuel cells of each sub-stack 12 are connected in series. The no-load Open Circuit Potential (OCP) of each fuel cell is approximately 1V (see FIG. 4, discussed in more detail below). Each sub-stack 12 therefore gives a voltage of approximately 4V.

FIG. 3 shows one fuel cell sub-stack 12 of the segmented fuel cell-battery arrangement, shown separately from the rest of the stack of which it forms part. As mentioned above with reference to FIG. 2, the sub-stack 12 consists of four fuel cells. Each fuel cell is composed of a membrane electrode assembly 31 sandwiched between two bipolar plates 32. At each end of the sub-stack 12, there is an insulating layer 15. In this embodiment, the membrane electrode assembly has a 25 cm² active area. The bipolar plates 32 are formed from graphite and ensure homogeneous distribution of the air, or oxygen, and the hydrogen to either side of the membrane electrode assemblies 31.

With reference again to FIG. 2, the battery in this embodiment is a lithium-ion battery. As mentioned above, lithium-ion batteries are the current preferred technology for automotive applications due to their superior volumetric and gravimetric energy densities when compared to other electrochemical energy storage devices. They have a high power density when compared to fuel cells. The lithium-ion battery is divided into individual battery cells 13.

Each battery cell 13 is connected in parallel to one of the sub-stacks 12 of the fuel cell stack. This pairing of a fuel cell sub-stack 12 with a battery cell 13 will be described herein as a unit cell 16. As a result of this parallel configuration, the voltage across the battery cell 13 and the voltage across the fuel cell sub-stack 12 will always be balanced when so connected. It will be understood by the skilled person that under load, the battery cell 13 and the fuel cell sub-stack 12 will have slightly different voltages across them due to losses from a diode 14 (described in more detail below) connected between them. As described in more detail below with reference to FIG. 4, lithium-ion batteries have to be kept within an operating voltage window of approximately 2.7-4.2 V. It is for this reason that, in this embodiment, each sub-stack 12 of the fuel cell stack is made up of four individual fuel cells connected in series. Thus the no-load open-circuit potential of each sub-stack is within the safe operating range of 2.7 to 4.2V of the respective battery cell 13 to which it is connected. As mentioned above, PEMFCs have a high energy density, while lithium-ion batteries have a high power density. The unit cells 16 have the combined power and energy density of both devices. The unit cell 16 is connected in series with other unit cells 16 (the fuel cells of which all form part of the same modified fuel cell stack) to increase the collective voltage to practical levels. In an alternative embodiment, each unit cell 16 is made up of two battery cells 13 connected in parallel with a fuel cell sub-stack composed of eight fuel cells connected in series. In this alternative embodiment, the voltage of the fuel cell sub-stack is within the safe operating voltage window of the two battery cells 13 connected in series. In other embodiments, more battery cells 13 connected in series may be connected in parallel with a fuel cell sub-stack composed of a greater number of fuel cells connected in series, provided that the open-circuit voltage of the sub-stack is within the safe operating voltage window of the battery cells 13 connected in series.

The division of the lithium-ion battery into individual battery cells 13 is made practicable in this arrangement 10—despite the fact that in the battery-only or fuel cell-battery hybrid systems discussed in the “background” section it is desirable to keep conditions homogeneous throughout the battery pack—because the above-discussed pairing of a battery cell 13 with a fuel cell sub-stack 12 ensures that the voltages across each of the battery cells 13 are balanced.

To avoid a battery cell 13 charging the fuel cell sub-stack 12 to which it is connected, a diode 14 is connected between each sub-stack 12 and battery cell 13. As mentioned above, an electrically insulating layer 15 insulates each sub-stack 12 from the sub-stack 12 to which it is adjacent in the fuel cell stack. The diodes 14 protect the fuel cells from being charged by the battery cells 13 under no-load conditions and when the arrangement 10 is shut down (i.e. when the fuel cell voltage drops to zero). The diodes 14 prevent current from flowing into the fuel cell stack 12 in these circumstances.

In this embodiment, the diodes 14 are silicone diodes. Standard silicone diodes have a voltage drop of between 0.6 and 1.7 V. In other embodiments, alternative low voltage diodes such as the Schottky, or hot carrier diode, are used. These diodes have a lower voltage drop (between 0.15 and 0.45V). The lower the voltage drop across the diode, the more efficient and responsive the arrangement 10 is to dynamic loads. In yet other embodiments, active switching is used as an alternative to the diodes 14. The switching breaks the link between the fuel cell and battery when the potential gradients change, effectively preventing current going into the fuel cell. By using active switching, power loss due to the use of diodes is eliminated, increasing the efficiency of the segmented fuel cell-battery arrangement 10.

In an alternative embodiment, the battery cells 13 are replaced by supercapacitors. These have higher power densities than batteries but lower energy densities and operative voltages. The operative voltage of a supercapacitor is typically less than 2.7V. In order substantially to match the voltage of a fuel cell stack 12 with a supercapacitor, fewer fuel cells would be connected in series to form the stack 12. More unit cells each made up of one or more supercapacitors and a fuel cell sub-stack are therefore used in this alternative embodiment to achieve the same collective voltage as the arrangement 10 of the first embodiment.

In a further alternative embodiment, the fuel cells are replaced by supercapacitors. As mentioned above, the operative voltage of a supercapacitor is typically less than 2.7V. In order substantially to match the voltage across the supercapacitors to the voltage across the battery cell 13 within a unit cell, more supercapacitors are connected in series to form a supercapacitor group connected in parallel with a battery cell.

In a yet further alternative embodiment, the fuel cells are replaced by redox flow batteries. The number of redox flow battery cells connected in parallel with one or more lithium-ion battery cells 13 to form a unit cell is chosen to balance the voltage across the redox flow battery cell or cells within a unit cell with the voltage across the lithium-ion battery cell or cells within that unit cell in order to keep both the lithium-ion battery cells and redox flow battery cells within their safe operating voltage ranges.

In another alternative embodiment, the fuel cells are replaced by supercapacitors the lithium-ion batteries are replaced by redox flow batteries. Again, the number of supercapacitors and the number of lithium-ion battery cells connected to form a unit cell is selected substantially to balance the voltages across these two different components with one another.

[Operation]

Returning now to the description of the first embodiment, the operation of the segmented fuel cell-battery arrangement 10 will be described. To aid understanding, the polarisation of a PEMFC will first be described with reference to FIG. 4, and the discharge of a lithium-ion battery cell will be described with reference to FIG. 5.

FIG. 4 shows the polarisation curve of a PEMFC. In the fuel cell, the no-load Open Circuit Potential (OCP) is approximately 1 V. Under load, three main losses account for the electrochemical inefficiencies of the system. The first loss comes from the activation overpotentials, which dominate at low current densities and represent the kinetic energy barriers of the Hydrogen Oxidation Reaction (HOR) and Oxygen Reduction Reaction (ORR). The activation overpotential-dominated region is shown in region 1 of FIG. 4. The second loss comes from the ohmic overpotentials, which arise due to the resistance of the fuel cell components such as the bipolar plates, membrane and contact resistances. Region 2 of FIG. 4 represents the ohmic overpotential-dominated region. The third loss comes from mass transport limitations, which dominate at high current densities and are caused by diffusion limitations of the reactants. The mass transport overpotential-dominated region is shown in region 3 of FIG. 4.

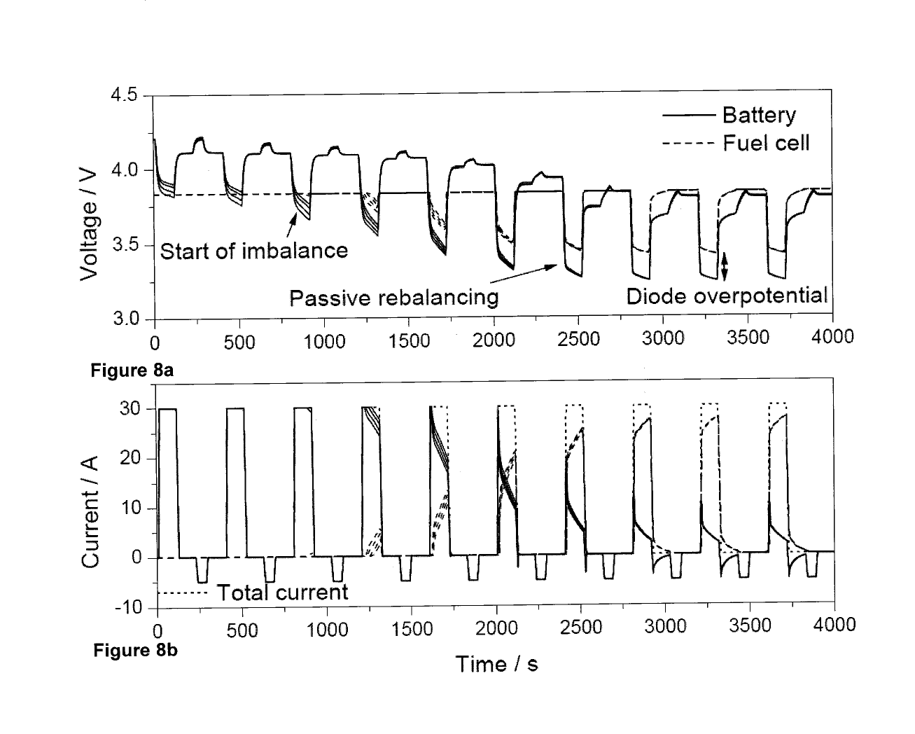

FIG. 5 shows the discharge curve of a lithium-ion battery. At higher discharge rates, the accessible capacity drops. This is due to the higher overpotential losses associated with the higher discharge rates. Lithium-ion batteries have to be kept within an operating voltage window of approximately 4.2-2.7 V. At voltages above 4.2 V, the battery starts to degrade. At such voltages, there is an increased risk of cathode decomposition and of lithium plating on the anode. This can lead to a reaction producing flammable gases, with the resultant danger that the battery may catch fire and explode. It is therefore greatly preferable to keep batteries within a certain voltage range to avoid excessive heat generation and to preserve the thermodynamic stability of the electrochemical system. In the present segmented fuel cell-battery arrangement 10, as will be discussed further below with reference to FIG. 8a, since the voltage of each fuel cell sub-stack 12 matches the voltage of its respective battery cell 13 (minus diode 14 overpotentials), the segmented fuel cell-battery arrangement 10 passively rebalances itself such that eventually the battery cell 13 voltages balance. The battery cells 13 therefore do not over-charge and over-discharge, and the risk of accelerated degradation or thermal runaway is reduced.

The operation of the segmented fuel cell-battery arrangement 10 as part of a drivetrain 1 will now be described with reference to FIG. 1. In steady-state operation, the motor controller 2 draws electrical power from the arrangement sufficient to drive the motor 11 at a speed that causes the vehicle of which the drivetrain 1 is a part to be conveyed along at a steady speed. The fuel cell stack is sized for the average power consumption of the motor 11. Peak power consumption is met using the battery.

The segmented fuel cell-battery arrangement 10 is particularly useful in applications where the load cycle is highly dynamic. As has been described, if the load 11 were constant, the fuel cell stack would after time supply all of the load, meaning that the battery cells 13 would not be required. If the user of the vehicle increases the power demand, for example by accelerating sharply, the motor controller 2 draws increased electrical power from the arrangement 10. Under braking conditions, the wheels 3 are arranged to drive the motor 11 and the motor 11 operates as a generator to charge the battery of the arrangement 10.

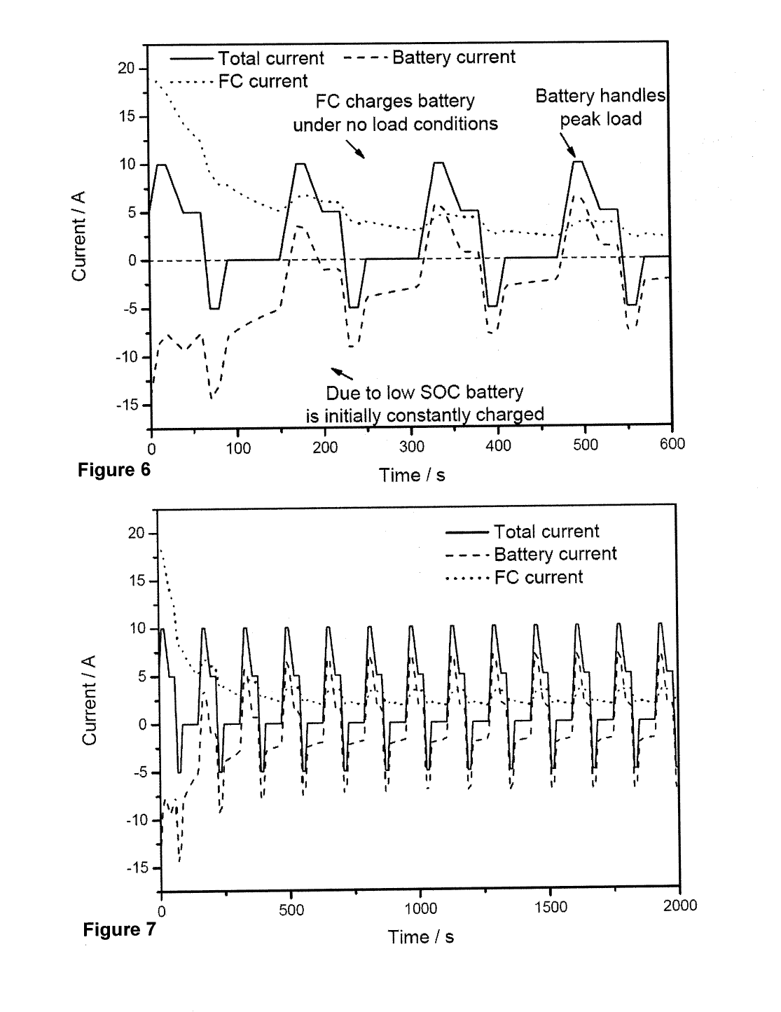

FIG. 6 shows the currents in the arrangement 10 under a dynamic load cycle consisting of a comparatively high discharge followed by a short recharge, repeated over 600 s. The total current against time is shown as a solid line, the total current supplied by the battery cells 13 (i.e. by the battery) is shown as a dashed line, and the current supplied by the fuel cell stack is shown as a dotted line. Initially, the SOC of the battery is low, and the fuel cell stack supplies the load as well as charging the battery. As the battery is charged, it begins to supply some of the load, but to continue to be charged by the fuel cell stack under no-load conditions. Gradually, the battery begins to supply the peak load.

FIG. 7 shows the currents in the segmented fuel cell-battery arrangement 10 under the dynamic load cycle over 2000 s. After the initial period shown in FIG. 6, the arrangement 10 settles into a cycle in which the battery supplies the peak load and the fuel cell stack charges the battery when there is no load on the segmented fuel cell-battery arrangement 10. As mentioned, the fuel cell stack meets the average power requirement of the load cycle due to its relatively high energy density. The battery buffers the transient loads of acceleration and deceleration. The arrangement 10 can therefore meet peak power loads with a fuel cell stack sized for average power loads, reducing the cost of the arrangement. As just mentioned, when there is no load demand from the drive cycle (i.e. when the vehicle which the segmented fuel cell-battery arrangement 10 of this embodiment is being used to power is idling), the fuel cell sub-stacks 12 provide power to the batteries 13. This improves the lifetime of the fuel cell stack, since fuel cell idling typically accounts for one third of automotive fuel cell degradation owing to accelerated carbon corrosion and catalyst dissolution. The diode 14 between each battery cell 13 and fuel cell sub-stack 12 ensures that no current flows from the battery cells 13 into the fuel cell stacks 12. As mentioned above to avoid their degradation and failure, fuel cells should not be electrically charged.

FIG. 8a shows the voltage response of the segmented fuel cell-battery arrangement 10 to dynamic loading, and FIG. 8b again shows the current response.

With reference to FIG. 8a, the voltage response of the battery cells 13 and the fuel cell sub-stacks 12 to the dynamic load will now be described. Since the battery cell 13 and sub-stack 12 of each unit cell 16 are connected in parallel with each other, the voltage of the battery cells 13 matches that of the fuel cell sub-stacks 12 under load, meaning that they each supply some of the load. When there is no load on the arrangement 10, the fuel cell sub-stacks 12 are able to recharge the battery cells 13 as described above since the thermodynamic sub-stack 12 voltage is above that of the battery cells 13. Over time, the battery cell 13 voltages begin to differ from one another. As, however, the voltage of each fuel cell sub-stack 12 matches the voltage of its respective battery cell 13, the arrangement 10 passively rebalances itself such that eventually the battery cell 13 voltages balance, avoiding the problems as described above with reference to FIG. 5.

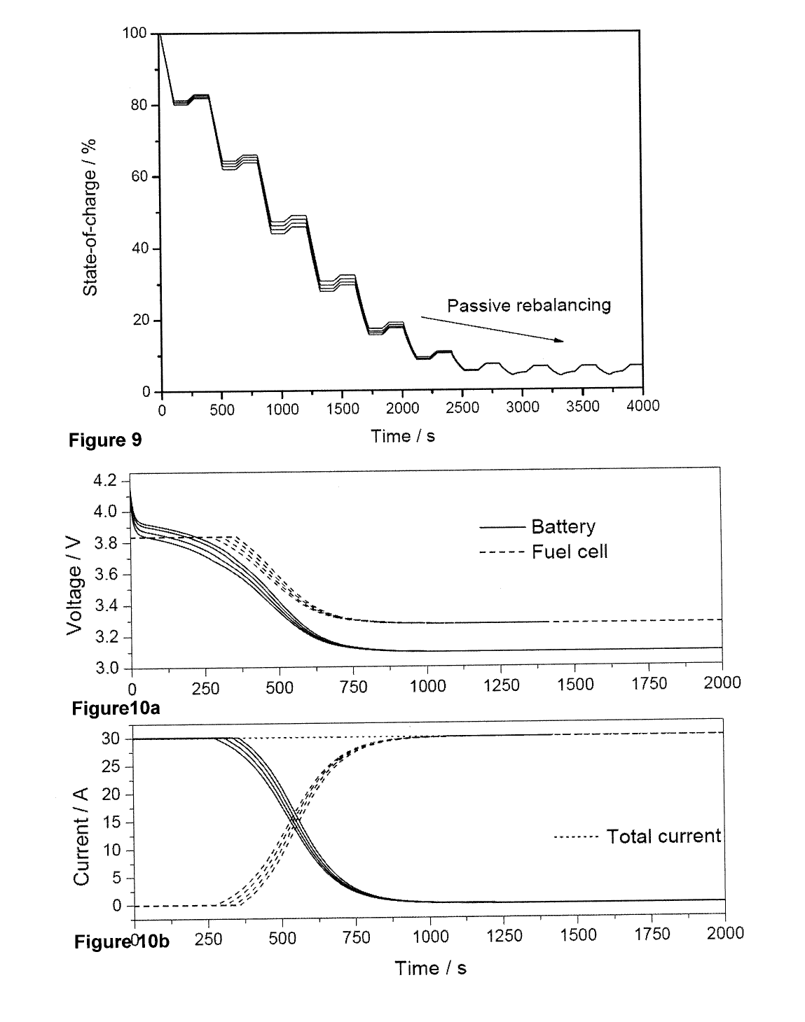

FIG. 9 shows how the states of charge of the battery cells 13 connected in series in the segmented fuel cell-battery arrangement 10 vary over time in response to the dynamic load of FIGS. 8a and 8b. Initially, when the fuel cell sub-stacks 12 are not active, the states of charge of the battery cells 13 gradually deviate. Towards the end of the load cycle, the fuel cell sub-stacks 12 have balanced the battery cells 13 such that their states of charge are the same. In FIG. 9, the steady state operation point of the battery cells 13 is at a relatively low SOC. The fuel cell sub-stacks 12 will therefore supply the majority of the load due to the higher impedance of the battery cells 13 at a lower SOC.

With reference again to FIG. 2, and in summary, the direct coupling of each battery cell 13 with a fuel cell sub-stack 12 means that a DC-to-DC converter is not required to convert the voltage of the battery cells to match the voltage of the fuel cells or vice versa. This is in contrast with the first hybrid arrangement discussed in the “background” section. When load is applied to the segmented fuel cell-battery arrangement 10, the battery cells 13 will meet the peak power requirements due to the lower impedance (resistance) of the battery cells 13, allowing for a smaller fuel cell stack to be used while still meeting peak power requirements. As the SOC of the battery cells 13 decreases, the fuel cell sub-stacks 12 will provide more power.

When load is zero (in this embodiment, when the vehicle which the segmented fuel cell-battery arrangement 10 powers is idling) the fuel cell sub-stacks 12 to which each battery cell 13 is connected will recharge each battery cell 13. Certain battery cells 13 after a discharge may be at a lower SOC due to operating conditions or manufacturing variations. As discussed in the “background” section, in pure battery and in battery-fuel cell hybrid vehicles, a BMS is used to rebalance the voltages. In the segmented configuration of this first embodiment, voltage balancing is achieved passively, removing the need for a BMS.

Since the arrangement 10 includes battery cells 13 in addition to the fuel cell stack, the segmented fuel cell-battery arrangement 10 is able to recover energy during braking of the vehicle. During this regenerative braking, the kinetic braking energy of a vehicle is transformed back into electrical power. Regenerative braking is not possible in pure fuel cell electric vehicles, since fuel cells are not able to absorb electrical energy.

As described above with reference to FIG. 7, transient loads experienced by the fuel cell, which are typical of vehicle drive cycles, will be passively smoothed. This increases the efficiency of the fuel cell. It also increases the durability of the fuel cell, as will now be described. Under ideal operating conditions the cell voltages of all cells in a fuel cell stack should be the same. The series nature of conventional fuel cell stacks dictates that all cells in the stack have to experience the same load. However, due to inhomogeneous operating conditions, some cells may be working under non-ideal conditions compared to others but experiencing the same current load due to all the cells being in series. For example, a hole in the membrane electrode assembly 31 (see FIG. 3) of one fuel cell would allow the mixing of hydrogen and oxygen within a fuel cell stack. This leads to the cell voltage falling to zero and is also potentially dangerous. Another failure mode is localised fuel starvation in which one or more of the fuel cells within a fuel cell stack does not receive sufficient hydrogen or oxygen. In both cases, catastrophic failure may be caused by the same load being pushed through the cell experiencing the failure as through the other cells in the fuel cell stack. The segmented fuel cell-battery arrangement 10 of the present embodiment prevents the same load from being applied to the failing fuel cell since the fuel cell sub-stacks 12 are connected in series, not in parallel, and are each connected in parallel to a battery cell 13. If one sub-stack 12 experiences sub-optimal operating conditions, the battery cells 13 take more of the load, thereby reducing the risk of failure. A fuel cell will eventually recover, for example, from localised fuel starvation, so reducing the load on a cell in a region of low oxygen or hydrogen prevents this transient condition from leading to permanent failure. Since the battery cells 13 take up the load, the segmented fuel cell-battery arrangement 10 can continue to run while one of or more of the fuel cells in the stack is experiencing such a transient condition, provided that the battery cells 13 are sufficiently charged.

In a conventional fuel cell stack, since the fuel cells are connected in series, if one of the fuel cells fails, the whole fuel cell performance degrades significantly, sometimes to the point of a total inoperability. In the present arrangement 10, even if one or more fuel cells within a fuel cell sub-stack were to fail, an alternative current route is provided. The passive localised coupling which balances the loads therefore makes the segmented fuel cell-battery arrangement 10 more robust to failure than a pure fuel cell system or a non-segmented fuel cell-battery hybrid. The fuel cell stack is often the most expensive part of a fuel cell-battery hybrid vehicle system and making the fuel cell stack more robust to failure can therefore significantly reduce costs.

As discussed above with reference to FIG. 2, the parallel connections with fuel cell sub-stacks make it possible the division of the lithium-ion battery into individual battery cells 13 possible. This segmentation in turn means that the low-voltage battery pack of a vehicle can be integrated into the main vehicle pack, allowing for rapid balancing and use of different capability cells in the same string. Integrating the low-voltage circuit of the vehicle into the main vehicle battery pack in this manner reduces the need for an extra battery pack and thus reduces cost.

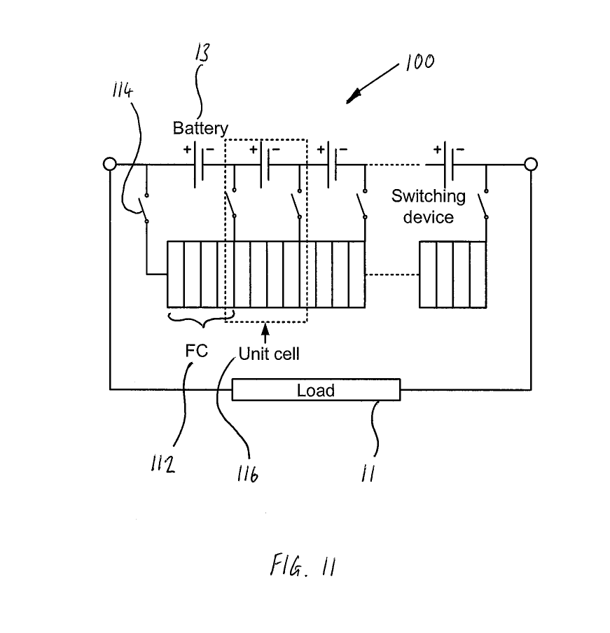

For comparison with the above-described segmented fuel cell-battery arrangement 10 response to dynamic loading (shown in FIGS. 6, 7, 8a and 8b), FIGS. 10a and 10b show the segmented fuel cell-battery arrangement 10 response to constant load. FIG. 10a shows the voltage response to constant (30A) loading of the arrangement 10. FIG. 10b shows the current response of the segmented fuel cell-battery arrangement 10 to the constant load. In FIG. 10a, the battery voltage against time is shown as a solid line, while the fuel cell voltage against time is shown as a dashed line. In FIG. 10b, the battery current against time is shown as a solid line, the fuel cell current against time is shown as a dashed line, and the total current against time is shown as a dotted line.

With reference to FIG. 10a, it can be seen that as the SOC of the battery cells 13 drops, and their voltage drops, the voltage of the fuel cell sub-stacks 12 also drops since each fuel cell stack 12 is connected in parallel with a battery cell 13, forming a unit cell 16 as described above with reference to FIGS. 2 and 3.

With reference to FIG. 10b, as the voltage of the battery cells 13 drops and they approach their under-load steady state, the fuel cell stacks 12 supply an increasing proportion of the load, until eventually the fuel cell stacks 12 supply nearly all of the load current.

Another embodiment that is a variation of the embodiment described above with reference to and shown in FIG. 2 and FIG. 3 will now be described with reference to FIG. 11. FIG. 11 shows an alternative segmented fuel cell-battery arrangement 100. In this alternative arrangement 100, the same reference numerals as used in FIG. 2 are used to refer to components that are substantially the same. As can be seen, this alternative embodiment is very similar to the FIG. 2 embodiment in comprising battery cells 13 connected in parallel with subsets of a fuel cell stack. Indeed, the underlying concept of fuel cell stack segmentation as a means of balancing cells of an energy storage device is the same. However, in this alternative embodiment, the insulating layers 15 of the FIG. 2 embodiment are removed from the fuel cell stack to give a plurality of fuel cell subsets 112 that are substantially as in the FIG. 2 embodiment, but without the insulating layers 15. The diodes 14 of the FIG. 2 embodiment are also removed and are replaced by switching devices, which in this embodiment are MOSFETs 114, although it is envisaged that other switching devices (e.g. mechanical relays) that have a substantially equivalent function may be used. As can be seen in FIG. 11, a MOSFET 114 is connected in place of each diode. (More precisely, it is envisaged that a pair of MOSFETs be connected in each of these positions in anti-series configuration and that each MOSFET in each pair is controllable to prevent current flowing selectively in each direction.) By replacing the insulating layers and diodes in this way, the number of components in the stack is reduced and also the associated losses of the diodes are avoided. However, this embodiment does require active control of the switching devices and also high current handling capabilities. It is therefore envisaged that appropriate control circuitry and logic be provided. This circuitry and logic is arranged to carry out the methods of operation described below.

In operation, and during regenerative braking of a vehicle to which this embodiment is fitted, the operating potential of each fuel cell subset 112 and the operating potential of each cell 13 of the battery are sensed. If the potential difference across a particular cell 13 of the battery is greater than that across the associated fuel cell subset 112 (the subset 112 which is arranged in parallel with the cell 13 of the battery), then the MOSFETs are operated in a way to avoid current flowing from the cell 13 of the battery to the associated fuel cell subset 112 in a direction that would “charge” the fuel cell subset 112 (such a current flow sometimes being referred to as “charging current flow”). It will be understood that current flowing into the fuel cell subset 112 in this way would irreversibly damage the catalyst of the fuel cell and lead to degradation.

This method of operation may be used in other circumstances. For example, it will be understood that, during operation, water tends to accumulate inside fuel cells causing flooding. As a result, the accumulated water can block gas delivery to components of the fuel cell, which, in effect, prevents reactant diffusion to reactive sites of the fuel cell. In the embodiments described in this document, this limitation in the reactant delivery can result in the potential across a fuel cell subset dropping and falling below the potential across the associated battery cell. As has already been explained, such a situation can result in current flowing to the fuel cell subset, leading to degradation of that component. By monitoring the potential of the battery cell 13 and of the associated fuel cell subset 112, and operating the MOSFETs between these two components to avoid current flow to the fuel cell subset 112, this problem is addressed. Thus, the method described above for use during regenerative braking may be used to good effect in other situations.

1. An apparatus for supplying electrical energy to a varying load, the apparatus comprising fuel cells and energy storage devices, wherein:
a fuel cell subset comprising one or a plurality of series-connected ones of the fuel cells, having a first no-load open-circuit potential thereacross, is connected in parallel with an energy storage device subset comprising one or a plurality of series-connected ones of the energy storage devices, having a second no-load open-circuit potential thereacross, to form a unit cell and the unit cell is connected in series or parallel with at least one other unit cell, and the fuel cells in the unit cell and the at least one other unit cell are fuel cells of the same fuel cell stack, wherein the first no-load open-circuit potential and the second no-load open circuit potential are substantially balanced.

2. An apparatus according to claim 1, wherein the fuel cells are hydrogen fuel cells.

3. An apparatus according to claim 1, wherein the fuel cells are proton exchange membrane fuel cells.

4. An apparatus according to claim 1, wherein the energy storage devices are batteries, wherein:
the energy storage devices are lithium-ion batteries;
the batteries are redox flow batteries and the fuel cells are regenerative fuel cells.

5. (canceled)

6. (canceled)

7. An apparatus according to claim 1, wherein the energy storage devices are supercapacitors.

8. An apparatus according to claim 1, wherein the unit cells are arranged to prevent charging of the or each fuel cell in the unit cell by the or each energy storage device to which the or each fuel cell is connected in a unit cell; and
wherein there is a diode or a functionally equivalent device in each unit cell, connected to prevent charging of the or each fuel cell in the unit cell by the or each energy storage device to which the or each fuel cell is connected in a unit cell.

9. (canceled)

10. An apparatus according to claim 8, wherein the diode is connected between each fuel cell subset and the respective energy storage device subset to which that fuel cell subset is connected.

11. An apparatus according to claim 8, wherein the diode is a silicon diode, or the diode is a Schottky diode.

12. (canceled)

13. An apparatus according to claim 8, wherein there is a switching device connected in series with the energy storage device and in parallel with the or each fuel cell in the or each unit cell.

14. An apparatus according to claim 1, wherein, in at least one of the unit cells, there is a switching device connected between the energy storage device subset and the fuel cell subset, the switching device operable to prevent charging current flow from the energy storage device subset to the fuel cell subset.

15. An apparatus according to claim 14, wherein the switching device is an electronically controllable switching device which includes either a MOSFET or a pair of MOSFETs arranged and operable to selectively prevent current flow in neither, either and/or both directions.

16. (canceled)

17. (canceled)

18. An apparatus according to claim 1, wherein there is a, or a respective, electrically insulating layer between the fuel cells of one unit cell and the adjacent fuel cell of the or each unit cell to which the one unit cell is physically adjacent;
wherein the material forming the electrically insulating layer is selected to allow gas to pass between the fuel cells of different unit cells.

19. (canceled)

20. An apparatus according to claim 14, and without an electrically insulating layer between physically adjacent fuel cell subsets.

21. An apparatus according to claim 1, wherein there is one energy storage device and four fuel cells in a unit cell.

22. An apparatus for supplying electrical energy to a varying load, the apparatus comprising supercapacitors and energy storage devices, wherein a supercapacitor subset comprising one or a plurality of series-connected ones of the supercapacitors, having a first no-load open-circuit potential thereacross, is connected in parallel with an energy storage device subset comprising one or a plurality of series-connected ones of the energy storage devices, having a second no-load open-circuit potential thereacross, to form a unit cell and the unit cell is connected in series or parallel with at least one other unit cell, wherein the first no-load open-circuit potential and the second no-load open circuit potential are substantially balanced.

23. A vehicle drivetrain comprising an apparatus according to claim 1.

24. (canceled)

25. An uninterruptible power supply comprising an apparatus according to claim 1.

26. A combined heat and power supply comprising an apparatus according to claim 1.

27. An apparatus for receiving electrical energy from a varying source, the apparatus comprising fuel cells and energy storage devices, wherein:
a fuel cell subset comprising one or a plurality of series-connected ones of the fuel cells, having a first open-circuit voltage thereacross, is connected in parallel with an energy storage device subset comprising one or a plurality of series-connected ones of the energy storage devices, having a second open-circuit voltage thereacross, to form a unit cell and the unit cell is connected in series or parallel with at least one other unit cell, and the fuel cells in the unit cell and the at least one other unit cell are fuel cells of the same fuel cell stack, wherein the first no-load open-circuit potential and the second no-load open circuit potential are substantially balanced;
wherein the fuel cells are regenerative fuel cells.

28. (canceled)

29. A method of operating an apparatus for supplying electrical energy to a varying load, the apparatus comprising fuel cells and energy storage devices, wherein a fuel cell subset comprising one or a plurality of series-connected ones of the fuel cells, having a first no-load open-circuit potential thereacross, is connected in parallel with an energy storage device subset comprising one or a plurality of series-connected ones of the energy storage devices, having a second no-load open-circuit potential thereacross, to form a unit cell and the unit cell is connected in series or parallel with at least one other unit cell, and the fuel cells in the unit cell and the at least one other unit cell are fuel cells of the same fuel cell stack, wherein the first no-load open-circuit potential and the second no-load open circuit potential are substantially balanced, wherein, in at least one of the unit cells, there is a switching device connected between the energy storage device subset and the fuel cell subset, the switching device operable to prevent charging current flow from the energy storage device subset to the fuel cell subset, the method comprising the steps of, for at least one of the unit cells: sensing the operating potential of the fuel cell subset and the operating potential of the energy storage device subset, and operating the switching device in the event that the operating potential difference of the energy storage device subset is greater than that of the associated fuel cell subset to avoid current flowing from the energy storage device subset to the associated fuel cell subset, thereby avoiding attempted charging of the fuel cell subset by the energy storage device subset.
